(19) United States
(12) Patent Application Publication
(10) Pub. No.: US 2009/0109822 A1
(43) Pub. Date: Apr. 30, 2009

(54) EXTERNAL STORAGE MODULE AND SHOCK ABSORPTION ELEMENT THEREOF

(75) Inventor: Kuo-Chin Hung, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 12/241,055

(22) Filed: Sep. 30, 2008

(30) Foreign Application Priority Data
Oct. 31, 2007 (TW) 96141066

(51) Int. Cl. G11B 33/02

(52) U.S. Cl. 369/75.11; G9B/33.002

(57) ABSTRACT

An external storage module includes a case, a storage device disposed in the case and a plurality of shock absorption elements. The case has a first connector and the storage device has a second connector corresponding to the first connector, wherein the second connector suits to electrically connect the first connector. The shock absorption elements are assembled at the sides of the storage device and the outer surface of each shock absorption element press and contact the inner surface of the case, wherein each shock absorption element includes a shock absorption body and a plurality of protruding structures disposed on the inner surface of the shock absorption body. The shock absorption bodies in association with the protruding structures are used to clamp at the sides of the storage device.

### CROSS-REFERENCE TO RELATED APPLICATION

This application claims the priority benefit of Taiwan application serial no. 96141066, filed on Oct. 31, 2007. The entirety of the above-mentioned patent application is hereby incorporated by reference herein and made a part of specification.

### BACKGROUND OF THE INVENTION

1. Field of the Invention

The present invention generally relates to a shock absorption element, and more particularly, to a shock absorption element able to buffer external impacts and an external storage module having the shock absorption elements.

2. Description of Related Art

Along with the progresses of science and technology, people's daily life is unimaginable without electronic apparatuses. In particular, along with the continuous developments of electronic technologies, electronic products with more humanized features and powerful functions are ceaselessly upgraded. For example, a handy external storage module was lunched on the market thanks to the progresses of science and technology. The above-mentioned external storage module can be connected to a portable computer, for example, a laptop computer, through a transmission line, so that a user can conveniently access the data saved in the external storage module.

Note that an external storage module is easily damaged due to shakes or improper impacts during carrying it or connecting it to a portable computer, so that a user may fail to normally access the data saved in the external storage module.

### SUMMARY OF THE INVENTION

Accordingly, the present invention is directed to a shock absorption element able to prevent a storage device from damage due to improper shocks.

The present invention is also directed to an external storage module with longer life.

To achieve the above-mentioned or other objectives, the present invention provides a shock absorption element, which suits to be disposed at a side of a storage device. The shock absorption element includes a shock absorption body and a plurality of first protruding structures disposed on the inner surface of the shock absorption body, wherein the shock absorption body in association with the first protruding structures are used to clamp at the side of the storage device.

In an embodiment of the present invention, the shock absorption body includes a first portion, a second portion and a third portion, wherein the third portion is connected between the first portion and the second portion, and the first protruding structures are disposed on the inner surfaces of the first portion, the second portion and the third portion.

In an embodiment of the present invention, the first portion is located on a top surface of the storage device, the second portion is located on a bottom surface of the storage device, the third portion is located on a side surface of the storage device, and both the thickness of the first portion along the direction perpendicular to the top surface and the thickness of the second portion along the direction perpendicular to the bottom surface are greater than the thickness of the third portion along the direction perpendicular to the side surface.

In an embodiment of the present invention, both the first portion and the second portion are an arc-shaped structure, and the inner surfaces of the first portion and the second portion are arc-shaped.

In an embodiment of the present invention, the shock absorption body further includes a fourth portion disposed on the same edges of the first portion, the second portion and the third portion.

In an embodiment of the present invention, at least a first protruding structure is disposed on the inner surface of the fourth portion.

In an embodiment of the present invention, the shock absorption element further includes a plurality of second protruding structures disposed on the outer surface of the shock absorption body.

In an embodiment of the present invention, the shock absorption body is a C-shape body.

The present invention also provides an external storage module, which includes a case, a storage device disposed in the case and a plurality of above-mentioned shock absorption elements, wherein the case has a first connector, the storage device has a second connector corresponding to the first connector, and the second connector suits to be electrically connected to the first connector; the shock absorption elements are disposed at the sides of the storage device, and the outer surface of each shock absorption element contact the inner surface of the case.

In an embodiment of the present invention, the material of the shock absorption elements can be rubber.

In an embodiment of the present invention, a plurality of second protruding structures of each shock absorption element contacts the inner surface of the case.

According to the present invention, a plurality of shock absorption elements are disposed between the storage device and the case. Each shock absorption element mainly includes a shock absorption body and a plurality of first protruding structures disposed on the inner surface of the shock absorption body, wherein the shock absorption body in association with the first protruding structures are used to clamp at a side of the storage device and the outer surface of each shock absorption element contact the inner surface of the case. In this way, the storage device can be firmly disposed in the case by using the shock absorption elements, where the shock absorption elements are able to effectively buffer harmful impacts due to improper forces applying on the storage device and thereby lengthen the life of the storage device.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a diagram of an external storage module according to an embodiment of the present invention.

FIG. 1B is a partially exploded diagram of the external storage module of FIG. 1A.

FIG. 1C is an enlarged view of the shock absorption element in FIG. 1B.

FIG. 2A is an assembly diagram of the storage device of FIG. 1B and a plurality of shock absorption elements of another embodiment of the present invention.

FIG. 2B is an enlarged view of the shock absorption element in FIG. 2A.

FIG. 3A is an assembly diagram of the storage device of FIG. 1B and a plurality of shock absorption elements of yet another embodiment of the present invention.

FIG. 3B is an enlarged view of the shock absorption element in FIG. 3A.

FIG. 4A is an assembly diagram of the storage device of FIG. 1B and a plurality of shock absorption elements of yet another embodiment of the present invention.

FIG. 4B is an enlarged view of the shock absorption element in FIG. 4A.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

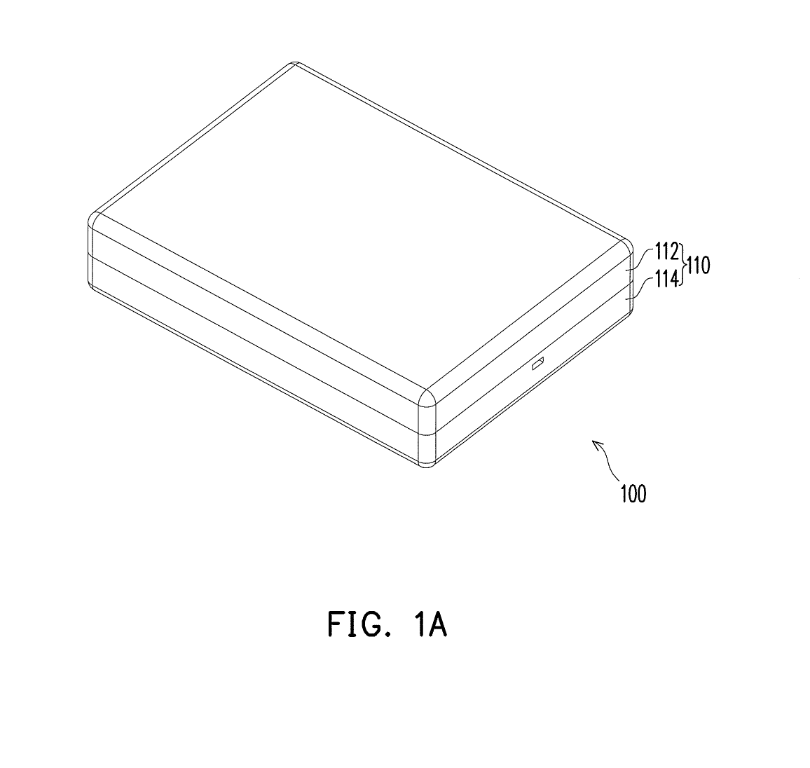

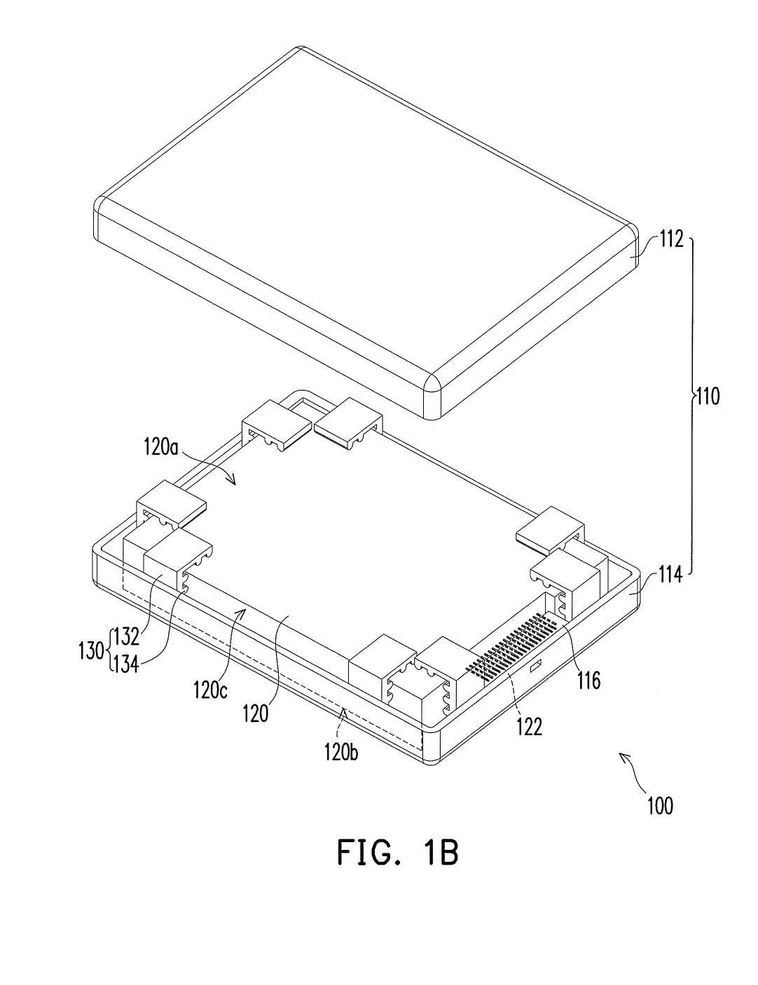

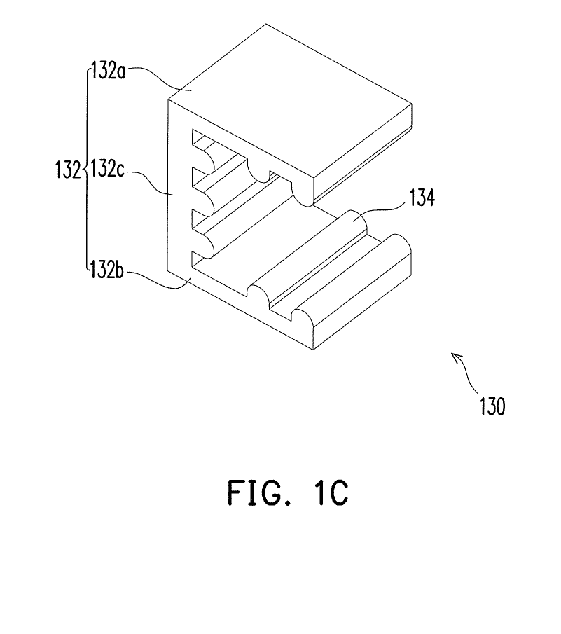

FIG. 1A is a diagram of an external storage module according to an embodiment of the present invention and FIG. 1B is a partially exploded diagram of the external storage module of FIG. 1A. Referring to FIGS. 1A and 1B, an external storage module 100 of the embodiment mainly includes a case 110, a storage device 120 disposed in the case 110 and a plurality of shock absorption elements 130. In the embodiment, the case 110 includes, for example, an upper case body 112 and a lower case body 114, and the lower case body 114 has a first connector 116 suitable to connect a transmission line (not shown). In addition, the storage device 120 (for example a hard disc) has a second connector 122 corresponding to the first connector 116, wherein the second connector 122 is suitable to be electrically connected to the first connector 116. In this way, the data saved in the storage device 120 can be delivered into a portable computer (for example, a laptop computer) for a user to use through electrically connecting the first connector 116 to the second connector 122 and a transmission line. The shock absorption elements 130 are assembled at the sides of the storage device 120, so that the storage device 120 can be firmly disposed in the case 110. The shock absorption elements 130 are explained in more detail hereinafter.

FIG. 1C is an enlarged view of the shock absorption element in FIG. 1B. Referring to FIGS. 1B and 1C, in the embodiment, the material of the shock absorption elements 130 is rubber with better elasticity or other proper elastic materials. Each shock absorption element 130 mainly includes a shock absorption body 132 and a plurality of first protruding structures 134 disposed on the inner surface of the shock absorption body 132, wherein the first protruding structures 134 and the shock absorption body 132 are, for example, integratively formed. Specially, the shock absorption body 132 is, for example, a C-shape body and includes a first portion 132a, a second portion 132b opposite to the first portion 132a and a third portion 132c connected between the first portion 132a and the second portion 132b. The first protruding structures 134 are disposed on the inner surfaces of the first portion 132a, the second portion 132b and the third portion 132c.

In the embodiment, the shock absorption body 132 in association with the first protruding structures 134 are used to clamp at the side of the storage device 120. The first portion 132a is located on a top surface 120a of the storage device 120, the second portion 132b is located on a bottom surface 120b of the storage device 120, and the third portion 132c is located on a side surface 120c of the storage device 120. In addition, when the storage device 120 and the shock absorption elements 130 assembled therewith at the sides of the storage device 120 are together squeezed and disposed in the case 110, the outer surfaces of the shock absorption bodies 132 contact the inner surface of the case 110.

Note that the shock absorption element 130 is made of, for example, rubber or other proper elastic materials and the shock absorption elements 130 are disposed evenly between the storage device 120 and the case 110, therefore when the external storage module 100 bears improper external impacts, the shock absorption elements 130 can protect the storage device 120 in the case 120 from damage. Specially, since the storage device 120 does not directly contact the case 110 due to the shock absorption bodies 132 of the shock absorption elements 130 located between the storage device 120 and the case 110, therefore, an improper external force can not directly hit the storage device 120. Moreover, when the improper force hits the storage device 120, the shock absorption elements 130 are able to absorb the impact energy of the force by means of appropriate elastic deformations of the shock absorption elements 130. In other words, the shock absorption elements 130 disposed between the storage device 120 and the case 110 can largely weaken the impact action born by the storage device 120.

In addition, the shock absorption bodies 132 of the shock absorption elements 130 in association with the first protruding structures 134 clamp the storage device 120 at the sides of the storage device 120, where the first protruding structures 134 are designed to have better clamping effect, and the outer surfaces of the shock absorption bodies 132 strongly contact the inner surface of the case 110, therefore, the storage device 120 is able to be firmly disposed in the case 110 and is unlikely shaken when the external storage module 100 encounters improper impacts. On the other hand, when the above-mentioned improper force is transmitted to the storage device 120 via the case 110 and the shock absorption elements 130, the regions bearing the force of the storage device 120 are restricted to the contact areas of the first protruding structures 134 with the storage device 120, wherein the contact areas between the first protruding structures 134 and the storage device 120 are far less than the areas of the inner surfaces of the shock absorption bodies 132. Therefore, an improper force has a less negative impact on the storage device 120. In short, the shock absorption elements 130 in the embodiment are able to effectively weaken the impact on the storage device 120 by an improper force, which consequently lengthens the life of the storage device 120.

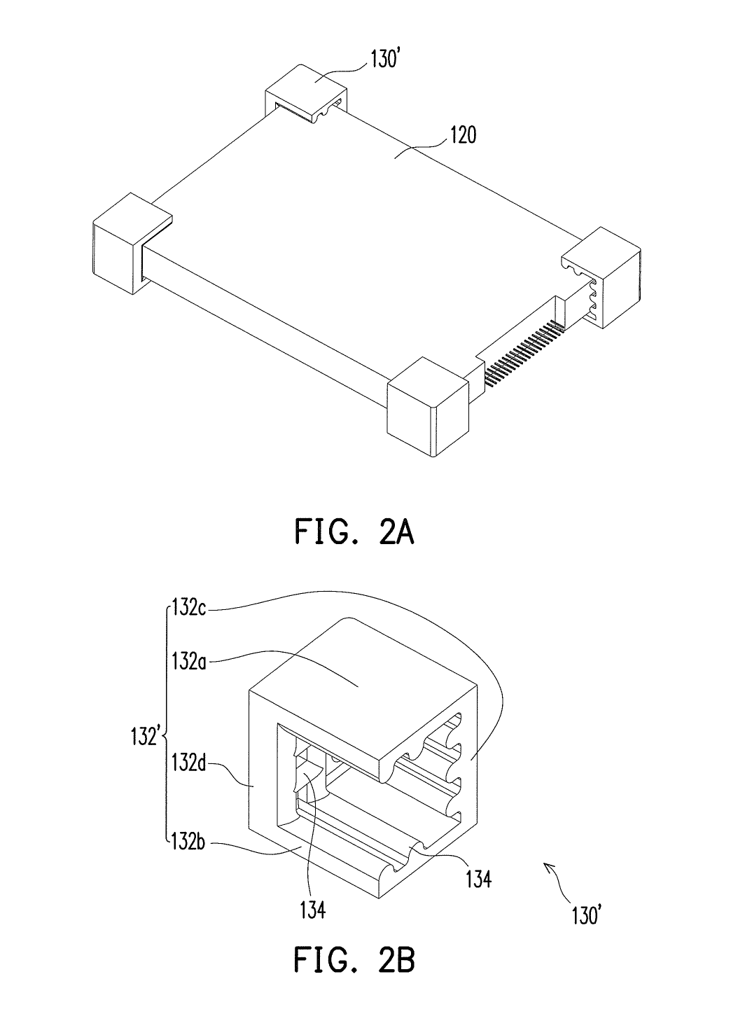

FIG. 2A is an assembly diagram of the storage device of FIG. 1B and a plurality of shock absorption elements of another embodiment of the present invention and FIG. 2B is an enlarged view of the shock absorption element in FIG. 2A. Referring to FIGS. 2A and 2B, the shock absorption element 130′ of the embodiment is similar to the shock absorption element 130 (as shown in FIG. 1C) of the above-mentioned embodiment except that the shock absorption body 132′ of the shock absorption element 130′ in the embodiment further includes a fourth portion 132d, which is disposed, for example, on the same edges of the first portion 132a, the second portion 132b and the third portion 132c. In addition, at least a first protruding structure 134 is disposed on the inner surface of the fourth portion 132d. When the shock absorption elements 130′ are assembled at the sides of the storage device 120, the shock absorption elements 130′ function in the same way to firmly clamp and hold the storage device 120 in the case, where the shock absorption elements 130′ are able to effectively weaken the impact on the storage device 120 by an improper force and consequently lengthen the life of the storage device 120.

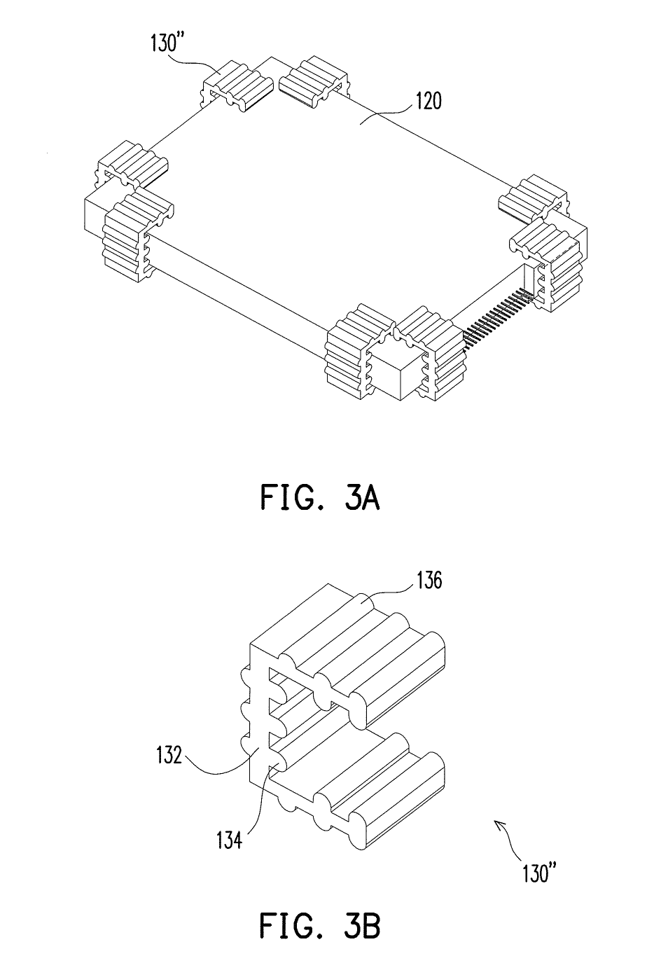

FIG. 3A is an assembly diagram of the storage device of FIG. 1B and a plurality of shock absorption elements of yet another embodiment of the present invention and FIG. 3B is an enlarged view of the shock absorption element in FIG. 3A. Referring to FIGS. 3A and 3B, the shock absorption element 130″ of the embodiment is similar to the shock absorption element 130 (as shown in FIG. 1C) of the above-mentioned embodiment except that a plurality of second protruding structures 136 is disposed on the outer surface of the shock absorption body 132 of the shock absorption element 130″. When the storage device 120 and the shock absorption elements 130″ assembled at the sides of the storage device 120 are together disposed in the case, the second protruding structures 136 on the outer surfaces of the shock absorption bodies 132 contact the inner surface of the case. Thus, when an improper force hits the external storage module, in addition to the above-mentioned shock absorption capability provided by the shock absorption elements 130 in the above-mentioned embodiment, the second protruding structures 136 on the outer surfaces of the shock absorption bodies 132 in the shock absorption elements 130″ of the embodiment would further weaken the impact energy which is transmitted from the case to the shock absorption bodies 132. That is to say, the shock absorption elements 130″ of the embodiment provide the storage device 120 with better shock absorption effect.

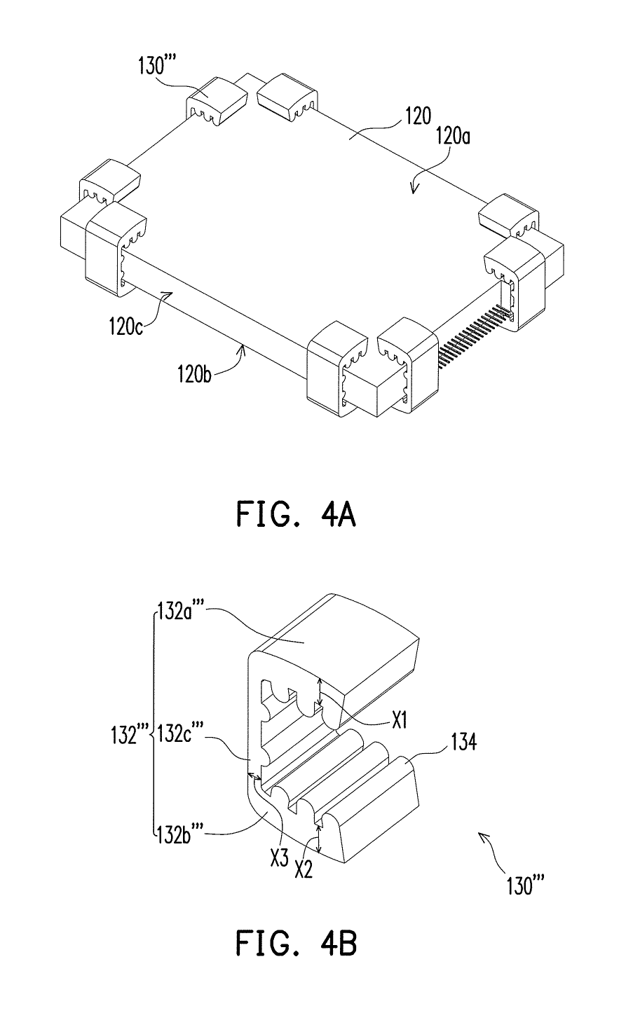

FIG. 4A is an assembly diagram of the storage device of FIG. 1B and a plurality of shock absorption elements of yet another embodiment of the present invention and FIG. 4B is an enlarged view of the shock absorption element in FIG. 4A. Referring to FIGS. 4A and 4B, the shock absorption element 130′″ of the embodiment is similar to the shock absorption element 130 (as shown in FIG. 1C) of the above-mentioned embodiment except that the first portion 132a′″ and the second portion 132b′″ of the shock absorption body 132′″ in the shock absorption element 130′″ of the embodiment are respectively an arc-shaped structure, and both the thickness X1 of the first portion 132a′″ and the thickness X2 of the second portion 132b′″ are greater than the thickness X3 of the third portion 132c′″. Specially, the inner surfaces of the first portion 132a′″ and the second portion 132b′″ are, for example, arc shaped, and the first protruding structures 134 are located on the arc inner surface, which provides the shock absorption element 130′″ with a lager clamping strength to firmly clamp the storage device 120 at the sides of the storage device 120.

Since the storage device 120 nowadays is developed towards the light-thin tendency, thus, the reading element (not shown) in the storage device 120 is more easily to get damaged due to an occasional hit onto the top surface 120a or the bottom surface 120b of the storage device 120, which even results in failure to read the data saved in the storage device 120. In order to better protect the reading element, both the thickness X1 of the first portion 132a′″ along the direction perpendicular to the top surface 120a and the thickness X2 of the second portion 132b′″ along the direction perpendicular to the bottom surface 120b are, for example, greater than the thickness X3 of the third portion 132c′″ along the direction perpendicular to the side surface 120c so as to more effectively buffer the impacts by an improper force onto the top surface 120a and the bottom surface 120b of the storage device 120. In other embodiments, both the thickness X1 of the first portion 132a′″ and the thickness X2 of the second portion 132b′″ can be roughly equal to the thickness X3 of the third portion 132c′″; or the thicknesses thereof can have other combinations.

In other embodiments, the present invention allows, but not limited to, to add a fourth portion on the same edges of the first portion, the second portion and the third portion, to dispose a plurality of second protruding structures on the outer surface of the shock absorption body, to increase the thicknesses of the first portion and the second portion or to design the structure of the shock absorption element with a combination of the above-mentioned features.

In summary, in the present invention, a plurality of shock absorption elements is squeezed and disposed between the storage device and the case, wherein each shock absorption element mainly comprises a shock absorption body and the first protruding structures on the inner surface of the shock absorption body. The shock absorption bodies in association with the first protruding structures clamp the storage device at the sides of the storage device, and the outer surfaces of the shock absorption bodies contact the inner surface of the case. The first protruding structures herein disposed on the inner surfaces of the shock absorption bodies are able to provide better clamping effect, and the outer surfaces of the shock absorption bodies press and contact the inner surface of the case; therefore, the storage device can be firmly disposed in the case.

In addition, when an improper force hits the external storage module and the improper force is transmitted to the storage device via the case and the shock absorption elements, since the regions bearing the force of the storage device are restricted to the contact areas of the first protruding structures, therefore, an improper force has a less negative impact on the storage device. That is to say, the shock absorption elements disposed between the storage device and the case are able to largely weaken the impact on the storage device by an improper force, which consequently lengthens the life of the storage device.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A shock absorption element, disposed on a side of a storage device, the shock absorption element comprising:
a shock absorption body; and
a plurality of first protruding structures, disposed on the inner surface of the shock absorption body, wherein the shock absorption body in association with the first protruding structures are used to clamp at the side of the storage device.

2. The shock absorption element according to claim 1, wherein the shock absorption body comprises a first portion, a second portion and a third portion, wherein the third portion is connected between the first portion and the second portion, and the first protruding structures are disposed on the inner surfaces of the first portion, the second portion and the third portion.

3. The shock absorption element according to claim 2, wherein the first portion is located on a top surface of the storage device, the second portion is located on a bottom surface of the storage device, the third portion is located on a side surface of the storage device, and both the thickness of the first portion along the direction perpendicular to the top surface and the thickness of the second portion along the direction perpendicular to the bottom surface are greater than the thickness of the third portion along the direction perpendicular to the side surface.

4. The shock absorption element according to claim 2, wherein both the first portion and the second portion are an arc-shaped structure.

5. The shock absorption element according to claim 2, wherein the shock absorption body further comprises a fourth portion disposed on the same edges of the first portion, the second portion and the third portion.

6. The shock absorption element according to claim 5, wherein at least a first protruding structure is disposed on the inner surface of the fourth portion.

7. The shock absorption element according to claim 1, further comprising a plurality of second protruding structures disposed on the outer surface of the shock absorption body.

8. The shock absorption element according to claim 1, wherein the shock absorption body is a C-shape body.

9. An external storage module, comprising:
a case, having a first connector;
a storage device, disposed in the case, wherein the storage device has a second connector corresponding to the first connector and the second connector is electrically connected to the first connector; and
a plurality of shock absorption elements, disposed on the sides of the storage device, wherein each shock absorption element comprises:
a shock absorption body, wherein the outer surface of the shock absorption body contacts the inner surface of the case; and
a plurality of first protruding structures disposed on the inner surface of the shock absorption body, wherein the shock absorption body in association with the first protruding structures are used to clamp at the side of the storage device.

10. The external storage module according to claim 9, wherein the shock absorption body comprises a first portion, a second portion and a third portion, wherein the third portion is connected between the first portion and the second portion, and the first protruding structures are disposed on the inner surfaces of the first portion, the second portion and the third portion.

11. The external storage module according to claim 10, wherein the first portion is located on a top surface of the storage device, the second portion is located on a bottom surface of the storage device, the third portion is located on a side surface of the storage device, and both the thickness of the first portion along the direction perpendicular to the top surface and the thickness of the second portion along the direction perpendicular to the bottom surface are greater than the thickness of the third portion along the direction perpendicular to the side surface.

12. The external storage module according to claim 10, wherein both the first portion and the second portion are an arc-shaped structure.

13. The external storage module according to claim 9, wherein each shock absorption element further comprises a fourth portion disposed on the same edges of the first portion, the second portion and the third portion.

14. The external storage module according to claim 13, wherein at least a first protruding structure is disposed on the inner surface of the fourth portion.

15. The external storage module according to claim 9, wherein the material of the shock absorption elements is rubber.

16. The external storage module according to claim 9, wherein each shock absorption element further comprises a plurality of second protruding structures disposed on the outer surface of the shock absorption body, and the second protruding structures contact the inner surface of the case.

17. The external storage module according to claim 9, wherein the shock absorption body is a C-shape body.
